(19) United States
(12) Patent Application Publication
(10) Pub. No.: US 2012/0247327 A1
(43) Pub. Date: Oct. 4, 2012

(54) HOLLOW-FIBER MEMBRANE CONTACTORS

(75) Inventor: Imona C. Omole, Owasso, OK (US)

(73) Assignee: CONOCOPHILLIPS COMPANY, Houston, TX (US)

(21) Appl. No.: 13/245,428

(22) Filed: Sep. 26, 2011

Related U.S. Application Data
(60) Provisional application No. 61/386,874, filed on Sep. 27, 2010.

(51) Int. Cl. B01D 53/22; B01D 53/14; B01D 71/32; B01D 71/34; B01D 71/66

(52) U.S. Cl. 95/51

(57) ABSTRACT

Methods and apparatus relate to recovery of carbon dioxide and/or hydrogen sulfide from a gas mixture. Separating of the carbon dioxide, for example, from the gas mixture utilizes a liquid sorbent for the carbon dioxide. The liquid sorbent contacts the gas mixture along asymmetric hollow-fiber membranes that enable transfer of the carbon dioxide from the gas mixture to the liquid sorbent.

### CROSS-REFERENCE TO RELATED APPLICATIONS

This application is a non-provisional application which claims the benefit of and priority to U.S. Provisional Application Ser. No. 61/386,874 filed Sep. 27, 2010, entitled “Hollow-Fiber Membrane Contactors,” which is hereby incorporated by reference in its entirety.

### STATEMENT REGARDING FEDERALLY SPONSORED RESEARCH OR DEVELOPMENT

None

### FIELD OF THE INVENTION

Embodiments of the invention relate to methods of making and using hollow-fiber membrane contactors.

### BACKGROUND OF THE INVENTION

Desire to remove acid gases such as carbon dioxide and hydrogen sulfide from various industrial processes requires efficient technology. Separation of the carbon dioxide or hydrogen sulfide from the mixture enables transport of the gas and subsequent handling or sequestering.

Factors determining suitability of possible techniques to separate the carbon dioxide or hydrogen sulfide include costs and energy requirements of the techniques. Separation approaches such as distillation are energy intensive. Absorption involves a sorbent to remove the carbon dioxide from the mixture followed by regeneration of the sorbent to liberate the acid gas.

Prior absorption units utilize columns or towers for direct contacting of the mixture with an absorbent fluid such as an aqueous amine. However, percentage of the acid gas within the mixture and/or amount of the acid gas removed dictate size, operating expense and capital expense of the units. Viability of these absorption units that may contain inefficient mass transfer devices such as trays begins to diminish as the amount of the acid gas to be separated increases.

Therefore, a need exists for methods of making and using hollow-fiber membrane contactors as efficient mass transfer devices in absorption systems for carbon dioxide and hydrogen sulfide separation.

### BRIEF SUMMARY OF THE DISCLOSURE

In one embodiment, a method of separating carbon dioxide and/or hydrogen sulfide from a gas includes passing the gas containing at least one of the carbon dioxide and the hydrogen sulfide through a contactor. The method further includes passing a liquid sorbent for the carbon dioxide through the contactor such that contacting of the gas and the liquid sorbent occurs across a membrane to treat the gas. The membrane forms walls of a hollow-fiber disposed within the contactor and has an asymmetric structure.

According to one embodiment, a method of separating carbon dioxide from a gas includes transferring the carbon dioxide from the gas mixture to a liquid sorbent through a first asymmetric hollow-fiber membrane. In addition, the method includes transferring the carbon dioxide from the liquid sorbent to steam through a second asymmetric hollow-fiber membrane. Condensing the steam separates the carbon dioxide transferred to the steam.

For one embodiment, a method of separating carbon dioxide from a gas includes forming a polymer such as polysulfone or polyvinylidene fluoride (PVDF) and hexafluoropropylene (HFP) copolymer asymmetric hollow-fiber membrane. Upon disposing the membrane in a contactor system, an interior bore of the membrane defines a first flow path through a sorption unit separate from a second flow path along an exterior of the membrane through the sorption unit. The carbon dioxide transfers from the first flow path to a liquid sorbent in the second flow path, or vice versa, at a contact interface across the membrane by passing the gas containing the carbon dioxide through the sorption unit along the first flow path and passing the liquid sorbent for the carbon dioxide through the sorption unit along the second flow path, or vice versa. The carbon dioxide and the liquid sorbent flow paths may be interchanged wherein the exterior of the membrane defines the first flow path for passing the gas containing the carbon dioxide and the interior bore of the membrane defines the second flow path for passing the liquid sorbent.

### BRIEF DESCRIPTION OF THE DRAWINGS

A more complete understanding of the present invention and benefits thereof may be acquired by referring to the following description taken in conjunction with the accompanying drawings.

FIG. 1 is a schematic of a contactor system with hollow-fiber membranes utilized in sorption and desorption units for separating carbon dioxide from a gas mixture, according to one embodiment of the invention.

FIG. 2 is a cross-sectional representation of one of the hollow-fiber membranes, according to one embodiment of the invention.

FIG. 3 is a schematic view of a wall section of the hollow-fiber membrane taken at oval III of FIG. 2, according to one embodiment of the invention.

FIG. 4 is an example of a collected hollow-fiber.

FIG. 5 is a depiction of skin layers of a hollow-fiber.

FIG. 6 is a depiction of skin layers of a hollow-fiber.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Embodiments of the invention relate to recovery of carbon dioxide and/or hydrogen sulfide from a gas mixture, such as flue gas or natural gas that may be recovered as hydrocarbon production from a sour gas field. While described herein with respect to carbon dioxide recovery, systems and methods disclosed also enable hydrogen sulfide (H₂S) recovery along with the carbon dioxide or in a same manner as the carbon dioxide recovery, if the hydrogen sulfide is present in the gas mixture either with or without the carbon dioxide. Separation of the carbon dioxide from the gas mixture utilizes a liquid sorbent for the carbon dioxide. The liquid sorbent contacts the gas mixture along asymmetric hollow-fiber membranes that enable transfer of the carbon dioxide from the gas mixture to the liquid sorbent, which may be aqueous amine solutions or ionic liquids.

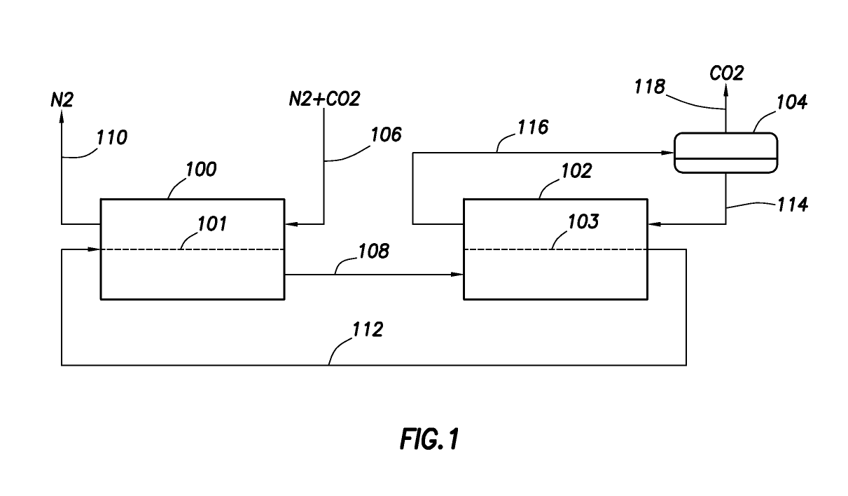

FIG. 1 illustrates a schematic of a contactor system including a sorption unit 100 and a desorption unit 102 coupled to a condenser and steam generator 104. In operation, a gas mixture 106, such as flue gas that contains nitrogen (N₂) and carbon dioxide (CO₂), enters the sorption unit 100. The gas mixture 106 passes through the sorption unit 100 along a flow path defined by a plurality of asymmetric hollow-fiber sorption membranes (represented by a dotted line) 101 that enable contact of the gas mixture 106 with a liquid stream of lean sorbent 112 passing through the sorption unit 100.

The carbon dioxide in the gas mixture 106 diffuses across the hollow-fiber sorption membranes 101. This diffusion at least reduces concentration of the carbon dioxide in a resulting treated output 110 of the sorption unit 100 relative to concentration of the carbon dioxide in the gas mixture 106 that is input into the sorption unit 100. The lean sorbent 112 that sorbs the carbon dioxide transferred through the sorption membranes 101 exits the sorption unit 100 as rich sorbent 108 for feeding into the desorption unit 102.

Steam 114 passes through the desorption unit 102 along a flow path defined by a plurality of asymmetric hollow-fiber desorption membranes (represented by a dotted line) 103 that enable contact of the rich sorbent 108 with the steam 114. Heat transfer across the desorption membranes 103 liberates the carbon dioxide from the rich sorbent 108 regenerating the lean sorbent 112 supplied to the sorption unit 100. The steam 114 and the carbon dioxide transferred into the flow of the steam 114 exit the desorption unit 102 as a combined vapor stream 116 input into the condenser and steam generator 104.

In the condenser and steam generator 104, the carbon dioxide separates from liquid water upon cooling of the combined vapor stream 116 and steam condensation. Overhead of the carbon dioxide separated from the water forms a recovered carbon dioxide output 118. Subsequent heating of the water by the condenser and steam generator 104 produces the steam 114 that is recycled for feeding to the desorption unit 102.

Conventional passing of amines through a re-boiler for regeneration increases corrosion problems compared to use of the desorption unit 102 with the rich sorbent 108 in contact with the desorption membranes 103 that are less prone to corrosion. Further, the sorption and desorption units 100, 102 provide insensitivity to motion and orientation that influence prior contacting approaches. The sorption and desorption units 100, 102 thus function in applications including floating facilities that can move during operation.

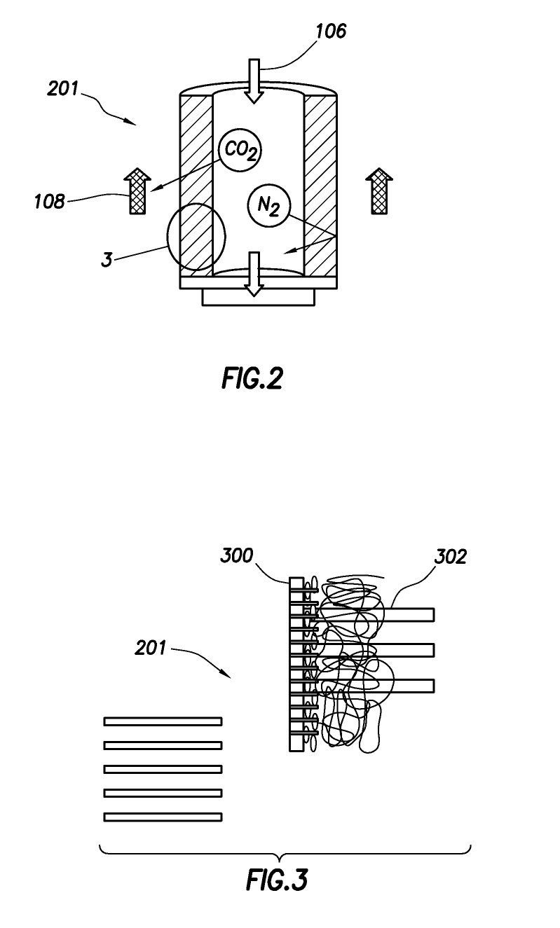

FIG. 2 shows a cross-sectional representation of a single membrane 201 referred to herein as hollow-fiber due to having a cylindrical structure with an open interior bore and a diameter between about 200 microns and about 2 millimeters. Multiple lengths of the membrane 201 assembled together may exemplify the membranes 101, 103 disposed in the units 100, 102 depicted in FIG. 1. For example, the gas mixture 106 containing the carbon dioxide may flow through the exterior of the membrane 201 without being dispersed in the lean sorbent 108 flowing along an interior bore of the membrane 201 and used for sorption of the carbon dioxide. In some embodiments, the lean sorbent 112 may flow through the exterior of the membrane 201 without being dispersed in the gas mixture 106 flowing along the interior bore of the membrane 201.

Although FIG. 2 depicts nitrogen and carbon dioxide flowing to the exterior of the membrane 201, in some embodiments it may be possible that nitrogen and carbon dioxide exists outside the membrane 201 and flow from the exterior of the membrane 201 to the interior of the membrane 201.

FIG. 3 illustrates morphological asymmetry in a wall section of the membrane 201 taken at oval III of FIG. 2. The wall section includes a skin layer 300 and a substructure 302. As discussed further herein, a common material may form the skin layer 300 and the substructure 302 during fabrication, which may facilitate forming of the asymmetry for control of mass transfer through the membrane 201 and liquid wetting of the membrane 201.

Packing density for multiple lengths of the membrane 201 and surface area of the membrane 201 enable efficient contacting. Compared with conventional packing that may provide only 250 square meters per cubic meter (m²/m³), the membrane 201 achieves surface areas of 1500 m²/m³ or more. The relative increase in surface area aides in reducing size and weight of equipment required for the contacting.

Pore size and surface energy of the membrane 201 maintain separation of a bulk gas phase (e.g., the gas mixture 106) from a bulk liquid solvent phase (e.g., the lean sorbent 108). This non-dispersive flow through the sorption unit 100 or the desorption unit 102 avoids problematic issues including flooding, entrainment, channeling and foaming that often occur with dispersive contacting. The non-dispersive flow enables control of gas and/or liquid flow rates without limitations of fluid-mechanics within towers that utilize the dispersive contacting.

The hydrophobic and solvophobic properties and the pore size help prevent liquids, such as the lean sorbent 112, from entering the membrane since the sorbents are usually aqueous. Avoiding such liquid penetration or wetting of the membrane 201 ensures that a stagnant liquid layer within pores of the membrane 201 does not obstruct transport of the carbon dioxide through the membrane since continuous flow otherwise replenishes fresh liquid flowing along the membrane 201. While the pore size of the membrane 201 must be large enough to permit efficient passage of the carbon dioxide, limiting the pore size at least at the skin layer 300 where liquids contact the membrane 201 inhibits the wetting.

The pore size and porosity however also influence gas throughput and mass transfer resistance of the carbon dioxide across the membrane 201. Increasing the pore size and/or the porosity along the substructure 302 where gas contacts the membrane 201 reduces the mass transfer resistance as desired even though the pore size and/or the porosity may not be able to be increased as much at the skin layer 300 without causing pore wetting problems. The substructure 302 provides physical integrity for the membrane 201 such that the skin layer 300 may have a limited thickness relied on only to prevent liquid breakthrough while maintaining high gas throughput.

For some embodiments, wall thickness of the membrane 201 only where the pore size prevents wetting defines the skin layer 300, which may be between 0.01 microns and 1 micron thick. The substructure 302 provides a remainder of the wall thickness of the membrane 201 and has pores that are too large to prevent the wetting. Overall the wall thickness of the membrane in some embodiments may range from 10 micron to 500 microns thick.

In some embodiments, a hydrophobic and/or solvophobic polymeric material that can be processed into the hollow-fiber thus forms the membrane 201. Suitable materials that form the membrane 201 can dissolve in a spinning solvent, be cast into the membrane 201 and be compatible with sorbent formulations desired for use in removing the carbon dioxide. Various exemplary compositions of polymer that may form the membrane 201 satisfy foregoing criteria and include but are not limited to sulfone-based polymers such as polysulfones, a polyvinylidene fluoride (PVDF), a PVDF and fluoropolymer copolymer, such as a PVDF and hexafluoropropylene (HFP) copolymer, or polymers of amides with various other constituent monomer combinations. The PVDF and HFP copolymer may contain between 0 and 20 weight percent of the HFP.

For some embodiments, a spinning process fabricates the membrane 201 from an extrusion mixture of the polymer (e.g., the polysulfone) and the solvent for the polymer into a quench bath that contains non-solvent for the polymer such that phase-separation is induced at the exterior of hollow-fiber, facilitating forming of the asymmetry with the skin layer on the exterior side of the hollow fiber.

For some embodiments, a spinning process fabricates the membrane 201 from an extrusion mixture of the polymer (e.g., the polysulfone), the solvent for the polymer and an additive that is more volatile than the solvent to facilitate forming of the asymmetry to control the mass transfer through the membrane 201 and the wetting of the membrane 201. The additive differs in composition from the solvent even though the additive may or may not dissolve the polymer by itself. Concentration of the additive in the extrusion mixture may range from about 1 weight percent to about 20 weight percent or from about 1 weight percent to about 10 weight percent.

For some embodiments, a spinning process fabricates the membrane 201 by extruding a mixture of the polymer (e.g., the polysulfone) in solution along with a non-solvent for the polymer through the interior bore such that phase separation is induced at the interior bore of the nascent hollow-fiber, facilitating forming of the asymmetry with the skin layer on the interior bore side of the hollow-fiber.

Examples of suitable solvents include N-methyl-2-pyrrolidone (NMP), dimethylformamide (DMF), dimethylacetamide (DMAc) and dimethyl sulfoxide (DMSO). These solvents provide miscibility in water (a suitable non-solvent) that is high enough to promote phase separation during quenching of the extrusion mixture in an aqueous media while spinning.

Concentration of the polymer in the extrusion mixture influences pore size and porosity given that pore size and porosity increase as the concentration of the polymer in the extrusion mixture decreases. The skin layer 300 forms due to relative increase in the concentration of the polymer toward where the solvent leaves during formation of the membrane 201 and upon exiting of the extrusion mixture from a spinneret nozzle. Due to evaporation of constituents other than the polymer, volatility of the constituents in the mixture influences concentration gradient of the polymer present at time of the quenching and across the membrane 201 from the skin layer 300 to the substructure 302.

In some embodiments, the additive enhances the evaporation at where the skin layer 300 forms by having a boiling point below 100° C. Examples of the additive that are capable of dissolving the polymer for some embodiments include acetone and tetrahydrofuran (THF). For some embodiments, the extrusion mixture includes the additive, such as ethanol, functioning as a non-solvent for the polymer. Such non-solvent compounds used as the additive result in the evaporation that maintains the extrusion mixture in a homogenous and stable state such that quenching produces lower pore sizes relative to quenching of the extrusion mixture after solvent-based evaporation, which causes the extrusion mixture to become less stable prior to quenching.

In addition to including the additive that is more volatile than the solvent, various parameters enable further modifying asymmetrical forming of the membrane 201 in order to control the mass transfer through the membrane and the liquid wetting of the membrane. For example, residence time that the mixture is exposed to ambient air prior to quenching in the aqueous media determines amount of evaporation allowed and hence how much the polymer is concentrated at the skin layer 300 due to the evaporation. Temperature of the mixture exiting the spinneret nozzle and surrounding air conditions including humidity, presence of vapors, temperature and air flow may further influence the formation of a skin layer.

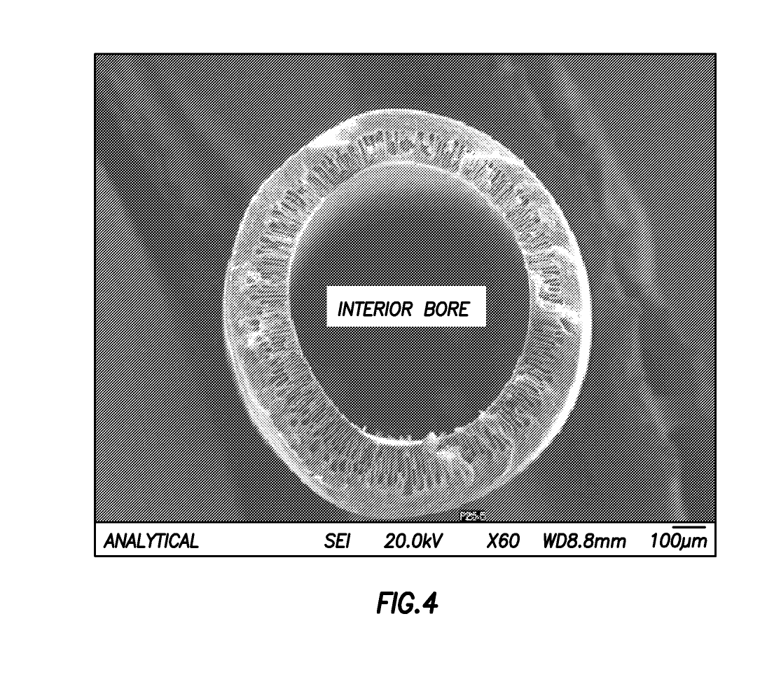

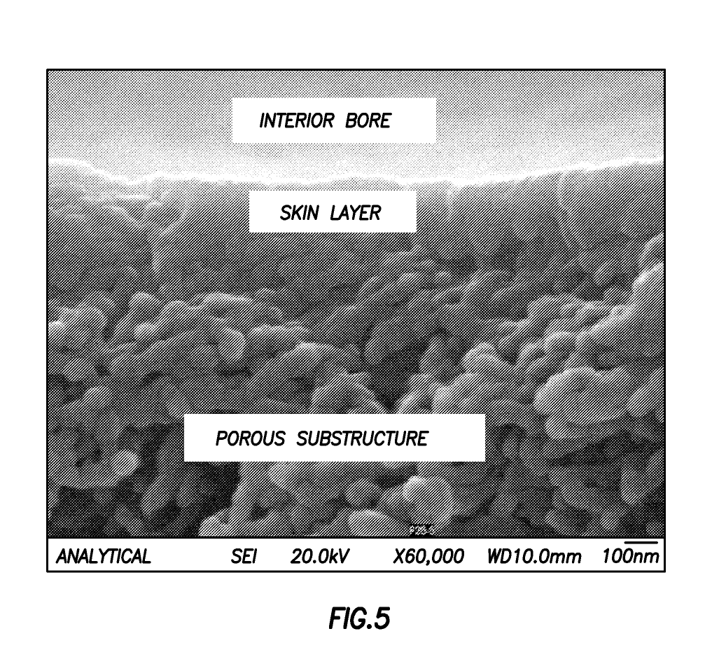

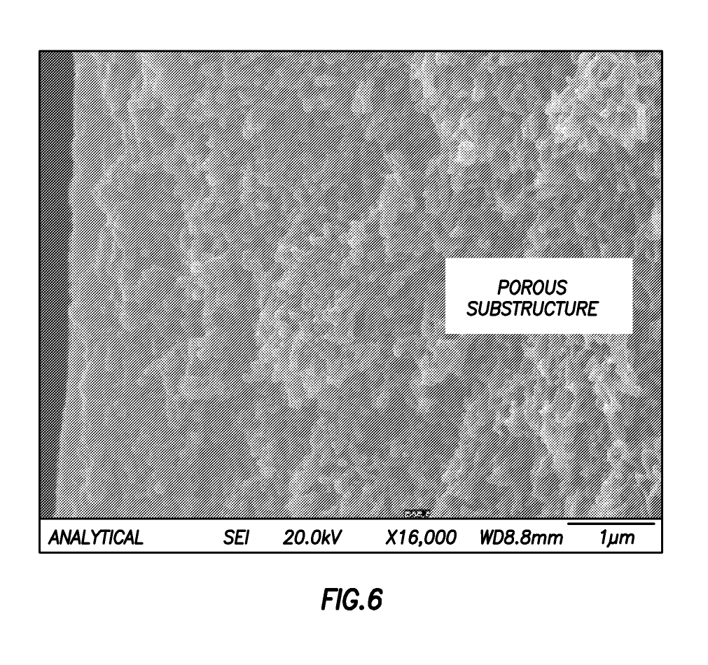

One method of creating the hollow fiber is to start with a homogeneous polymer solution containing 25% polysulfone, 72% NMP, and 3% water by weight and extruding at 30° C., and at an extrusion rate of 600 ml/hr, through a spinneret annulus at 30° C. Through the bore of the spinneret, a bore fluid containing water was coextruded at 450 ml/hr. The extruded fluids passed through an air-gap of ˜0.5 cm into a 40° C. quench bath containing 30% NMP and 70% water by weight. The hollow-fiber formed during the process was collected over a collection drum at 12 m/min. An example of the collected hollow-fiber can be seen in FIG. 4. The hollow-fibers show skin layers on the interior bore as shown in FIG. 5 and FIG. 6, useful for passing liquid solvents in the interior bore flow path.

In one example a hollow-fiber bundle was created by assembling 4 fibers into a 0.25-inch module with an active fiber length of ˜13 cm. The total surface area of the hollow-fibers was ˜20 cm2. Using pure gases, the permeance of carbon dioxide and nitrogen through the hollow-fibers was measured to be 700 GPU and 752 GPU respectively, where 1 GPU is defined as 1×10⁻⁶ cc(STP)/cmHg·sec·cm². It is theorized that this high gas permeance is a result of the asymmetric structure that constitutes the hollow-fiber membrane contactor.

In another example a hollow-fiber bundle was created by assembling 20 fibers into a 0.5-inch module with an active fiber length of ˜13.5 cm. The total surface area of the hollow-fibers was ˜102 cm². A gas mixture containing ˜18% CO₂ and balance nitrogen was passed through the exterior of the hollow-fiber bundle at a rate of ˜140 ml/min. On the opposite side of the hollow-fiber, a solvent containing ˜3% monoethanolamine by weight in water was passed countercurrently through the interior bore of the hollow-fibers at ˜30 ml/min. Although the amine content in the solution was relatively small, the carbon dioxide content in the gas mixture on the exterior of the hollow-fibers was reduced from ˜18% to about 9.5%.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method, comprising:
passing a gas containing at least one of carbon dioxide and hydrogen sulfide through a contactor; and
passing a liquid sorbent for at least one of the carbon dioxide and the hydrogen sulfide through the contactor such that contacting of the gas and the liquid sorbent to treat the gas occurs across a membrane that has an asymmetric structure and forms walls of a hollow-fiber disposed within the contactor.

2. The method according to claim 1, wherein the membrane is made of a polymer able to be dissolved in a spinning solvent and compatible with the liquid sorbent.

3. The method according to claim 1, wherein the membrane is made by spinning a mixture of polymer and a spinning solvent and an non-solvent for the polymer to facilitate forming of the asymmetric structure on either side of the membrane for control of mass transfer through the membrane and wetting of the membrane by the liquid sorbent.

4. The method according to claim 1, wherein the membrane is made by spinning a mixture of polymer, solvent for the polymer and an additive that is more volatile than the solvent to facilitate forming of the asymmetric structure for control of mass transfer through the membrane and wetting of the membrane by the liquid sorbent.

5. The method according to claim 1, wherein the membrane is made by spinning a mixture of polymer, solvent for the polymer and between 1 and 15 weight percent of an additive that is more volatile than the solvent to facilitate forming of the asymmetric structure for control of mass transfer through the membrane and wetting of the membrane by the liquid sorbent.

6. The method according to claim 1, wherein the membrane is made by spinning a mixture of polymer, solvent for the polymer and an additive that is different than the solvent and selected from acetone, tetrahydrofuran and ethanol to facilitate forming of the asymmetric structure for control of mass transfer through the membrane and wetting of the membrane by the liquid sorbent.

7. The method according to claim 1, wherein the membrane is made by spinning a mixture of polymer, solvent for the polymer and an additive that has a boiling point below 100° C. to facilitate forming of the asymmetric structure for control of mass transfer through the membrane and wetting of the membrane by the liquid sorbent.

8. The method according to claim 1, wherein the membrane is made from a mixture of polymer, solvent for the polymer and an additive that results in selective reduction in porosity on one side of the membrane relative to an opposite side of the membrane.

9. The method according to claim 1, wherein the membrane is made of a polymer that includes polyvinylidene fluoride (PVDF).

10. The method according to claim 1, wherein the membrane is made of a sulfone-based aromatic polymer.

11. The method according to claim 1, wherein the gas passes through an interior bore and/or exterior of the membrane defining a first flow path separate from a second flow path along an exterior of the membrane and/or an interior bore and through which the liquid sorbent passes.

12. The method according to claim 1, further comprising passing the liquid sorbent into contact with steam along a membrane interface after the liquid sorbent is contacted with the gas containing the carbon dioxide, wherein the carbon dioxide transferred to the liquid sorbent during contact with the gas desorbs from the liquid sorbent and transfers to the steam for recovery.

13. The method according to claim 1, wherein the liquid sorbent is an aqueous amine.

14. The method according to claim 1, wherein the liquid sorbent is an aqueous amine and the membrane is made of a polyvinylidene fluoride (PVDF) and hexafluoropropylene (HFP) copolymer.

15. A method, comprising:
transferring carbon dioxide from a gas mixture to a liquid sorbent through a first asymmetric hollow-fiber membrane;
transferring the carbon dioxide from the liquid sorbent to steam through a second asymmetric hollow-fiber membrane; and
condensing the steam to separate the carbon dioxide transferred to the steam.

16. The method according to claim 15, wherein formation of the first and second membranes is from a mixture of polymer, solvent for the polymer and an additive that is more volatile than the solvent to facilitate asymmetrical forming of the membrane for control of mass transfer through the membrane and liquid wetting of the membrane.

17. The method according to claim 15, wherein the first and second membranes are made of a polyvinylidene fluoride (PVDF) and hexafluoropropylene (HFP) copolymer.

18. A method, comprising:
forming a polyvinylidene fluoride (PVDF) and hexafluoropropylene (HFP) copolymer asymmetric hollow-fiber membrane;
disposing the membrane in a contactor system with an interior bore of the membrane defining a first flow path through a sorption unit separate from a second flow path along an exterior of the membrane through the sorption unit;
passing a gas containing carbon dioxide through the sorption unit along the first flow path; and
passing a liquid sorbent for the carbon dioxide through the sorption unit along the second flow path, wherein the carbon dioxide is transferred from the first flow path to the liquid sorbent in the second flow path at a contact interface across the membrane.

19. The method according to claim 18, wherein porosity of the membrane increases from the interior bore of the membrane toward the exterior of the membrane.

20. The method according to claim 18, wherein the forming of the membrane includes modifying asymmetrical forming of the membrane in order to control mass transfer through the membrane and liquid wetting of the membrane.

21. The method according to claim 18, further comprising:
passing the liquid sorbent through a third flow path along the exterior of the membrane within a desorption unit of the contactor system; and
passing steam through a fourth flow path defined by the interior bore of the membrane within the desorption unit, wherein the steam and liquid sorbent contact across the membrane and the carbon dioxide transferred to the liquid sorbent desorbs from the liquid sorbent and transfers to the steam for recovery of the carbon dioxide.
